(19) United States
(12) Patent Application Publication
(10) Pub. No.: US 2026/0192567 A1
(43) Pub. Date: Jul. 9, 2026

(54) INKJET RECORDING APPARATUS

(71) Applicant: KYOCERA Document Solutions Inc., Osaka (JP)

(72) Inventors: Yasutaka INUI, Osaka (JP); Shunsuke YAMASAKI, Osaka (JP); Shuhei KAWAMATA, Osaka (JP); Yuko YANO, Osaka (JP)

(73) Assignee: KYOCERA Document Solutions Inc., Osaka (JP)

(21) Appl. No.: 19/439,102

(22) Filed: Jan. 2, 2026

(30) Foreign Application Priority Data
Jan. 6, 2025 (JP) 2025-001777

(51) Int. Cl. B41J 2/165

(52) U.S. Cl. CPC B41J 2/16552; B41J 2/16502; B41J 2002/16558

(57) ABSTRACT

The inkjet recording apparatus includes a head unit, a cleaning member, and a container member which, by being pressed from above to below, is displaced from a first position to a second position, the container member functioning in the second position to supply the cleaning member with a detergent. The container member includes a containing part for containing the detergent, and a base part which adjoins the containing part in a first direction perpendicular to an up/down direction. The head unit has a head base, and the head base presses the base part from above to below without making contact with the containing part so that the container member is displaced from the first position to the second position.

### INCORPORATION BY REFERENCE

This application is based on and claims the benefit of priority from Japanese Patent Application No. 2025-001777 filed on January 6, 2025, the contents of which are hereby incorporated by reference.

### BACKGROUND

The present disclosure relates to an inkjet recording apparatus equipped with recording heads.

An inkjet recording apparatus ejects ink from recording heads to form an image on a recording medium. Each of the recording heads has a nozzle surface (ink ejection surface). Ink is ejected from the nozzle surface.

### SUMMARY

An inkjet recording apparatus according to one aspect of the present disclosure includes a head unit, a cleaning member, and a container member. The head unit includes a recording head having a nozzle surface for ejecting ink. The cleaning member cleans the nozzle surface with a detergent. The container member contains the detergent and, by being pressed from above to below, is displaced from a first position to a second position, the container member functioning in the second position to supply the cleaning member with the detergent. The container member includes a containing part and a base part. The containing part has an upwardly-opening recessed area for containing the detergent therein. The base part adjoins the containing part in a first direction perpendicular to an up/down direction. The head unit has a head base for holding the recording head. The head base presses the base part from above to below without making contact with the containing part so that the container member is displaced from the first position to the second position.

### BRIEF DESCRIPTION OF THE DRAWINGS

FIG. 1 is an outlined view of an inkjet recording apparatus according to one embodiment;

FIG. 2 is a block diagram of the inkjet recording apparatus according to one embodiment;

FIG. 3 is a schematic diagram of a head unit according to one embodiment, as viewed in an up/down direction;

FIG. 4 is a schematic diagram of the head unit according to one embodiment, as viewed in a front/rear direction;

FIG. 5 is a schematic diagram showing a positional relationship between the head unit and a maintenance unit according to one embodiment;

FIG. 6 is a perspective view schematically showing the maintenance unit (with a cap unit omitted) according to one embodiment;

FIG. 7 is a perspective view schematically showing a container member according to one embodiment;

FIG. 8 is a schematic diagram of the container member according to one embodiment, as viewed from above;

FIG. 9 is a schematic diagram showing a positional relationship between the container member and a supply plate before supply of detergent to the container member according to one embodiment;

FIG. 10 is a schematic diagram of an aspect in which the container member is viewed in a second direction before being supplied with the detergent from the supply plate according to one embodiment;

FIG. 11 is a schematic diagram of an aspect in which the container member is viewed in the second direction during supply of the detergent from the supply plate according to one embodiment;

FIG. 12 is a schematic diagram showing a positional relationship between the container member and a recording head before cleaning of a nozzle surface with the detergent according to one embodiment;

FIG. 13 is a schematic diagram of an aspect in which the container member is viewed in the second direction before supply of the detergent to a cleaning member according to one embodiment;

FIG. 14 is a schematic diagram of an aspect in which the container member is viewed in the second direction during supply of the detergent to the cleaning member according to one embodiment;

FIG. 15 is a schematic diagram for explaining behavior of the cleaning member during cleaning of the nozzle surface according to one embodiment;

FIG. 16 is a schematic diagram of a container member according to a modification, as viewed from above; and

FIG. 17 is a sectional view taken along a line A-A' of FIG. 16.

### DETAILED DESCRIPTION

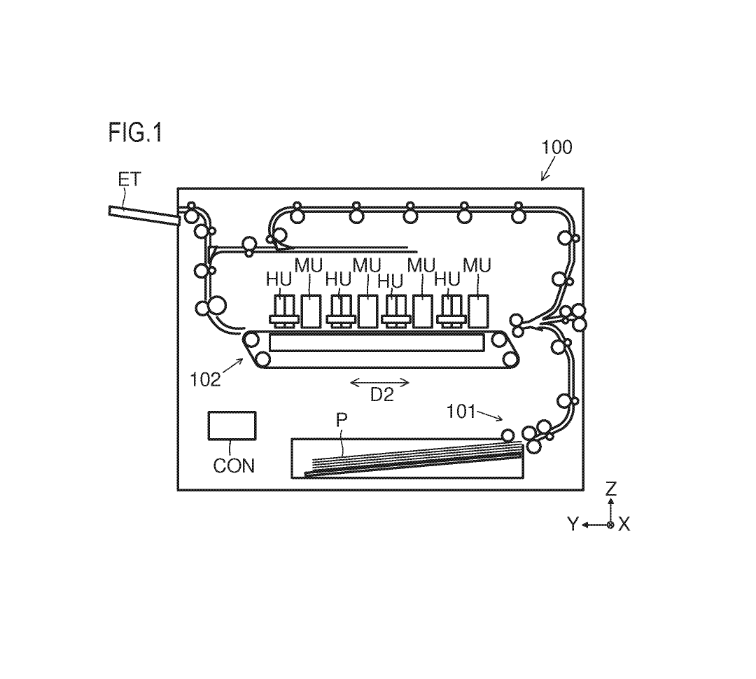

Hereinafter, an inkjet recording apparatus 100 according to this embodiment will be described with reference to FIGS. 1 to 15. The inkjet recording apparatus 100 is an image forming apparatus of inkjet type, which performs printing with ink. The inkjet recording apparatus 100 ejects ink to a recording medium to form an image on the recording medium. The recording medium is not particularly limited in type. As an example, sheets P of paper are used as the recording medium.

In the drawings to be referenced in the following description, XYZ orthogonal coordinate systems are shown for an easier understanding. A Z direction is a vertical direction, i.e., an up/down direction of the inkjet recording apparatus 100. A generally flat surface on which the inkjet recording apparatus 100 is installed is a plane perpendicular to the Z direction. An arrow-pointing direction of a Z axis is an upward direction, and its opposite direction is a downward direction.

An X direction is one of horizontal directions, and a Y direction is another of the horizontal directions. For example, the X direction is a front/rear direction of the inkjet recording apparatus 100. The Y direction is a left/right direction of the inkjet recording apparatus 100. In terms of printing by the inkjet recording apparatus 100, the X direction functions as a main scanning direction, and the Y direction functions as a sub scanning direction.

It is noted that the front/rear direction (X direction) of the inkjet recording apparatus 100, which corresponds to 'first direction', will hereinafter be referred to as 'first direction D1' from time to time. Also, the left/right direction (Y direction) of the inkjet recording apparatus 100, which corresponds to 'second direction', will hereinafter be referred to as 'second direction D2' from time to time.

### Configuration of Inkjet Recording Apparatus

The inkjet recording apparatus 100, as shown in FIG. 1, includes head units HU. The inkjet recording apparatus 100 also includes maintenance units MU. The head units HU eject ink to a sheet P to form an image on the sheet P. The maintenance units MU perform maintenance of the head units HU, respectively. Each head unit HU and each maintenance unit MU will be detailed later in their configuration.

The inkjet recording apparatus 100 conveys the sheet P. Further, the inkjet recording apparatus 100 forms an image on the under-conveyance sheet P. With this configuration, the inkjet recording apparatus 100 is equipped with a sheet feed part 101 and a conveyance part 102.

The sheet feed part 101 includes a sheet feed cassette on which sheets P are contained. The sheet feed part 101 also includes a sheet feed roller set in contact from above with a sheet P in the sheet feed cassette. The sheet feed part 101 drives the sheet feed roller into rotation to pull out sheets P from the sheet feed cassette sheet by sheet, feeding out each sheet P to the conveyance part 102.

The conveyance part 102 includes an endless conveyor belt. The conveyor belt is stretched by a plurality of stretching rollers including a driving roller. The driving roller coupled to a motor (not shown) is rotated with motive power transmitted from the motor. Rotation of the driving roller causes the conveyor belt to be driven.

The conveyance part 102 sucks and holds the sheet P fed from the sheet feed part 101 on an outer circumferential surface of the conveyor belt. For example, a plurality of suction holes extending through the conveyor belt in its thicknesswise direction are formed in the conveyor belt. On an inner circumferential side of the conveyor belt, suction units for sucking the sheet P on the outer circumferential surface of the conveyor belt are placed. As the suction units are driven, the sheet P is sucked up onto the outer circumferential surface of the conveyor belt. The conveyance part 102 sucks and holds the sheet P on the outer circumferential surface of the conveyor belt and, in this state, drives the conveyor belt. As a result, the sheet P is conveyed.

During the conveyance of the sheet P by the conveyor belt of the conveyance part 102, ink is ejected onto the sheet P from above. As a result, an image is formed on the under-conveyance sheet P. Thereafter, the sheet P is discharged onto a discharge tray ET.

The inkjet recording apparatus 100 is also equipped with a controller CON. The controller CON includes processing circuits such as CPU and ASIC. The controller CON further includes storage devices such as ROM, RAM, HDD, SSD, etc. The controller CON controls printing by the inkjet recording apparatus 100.

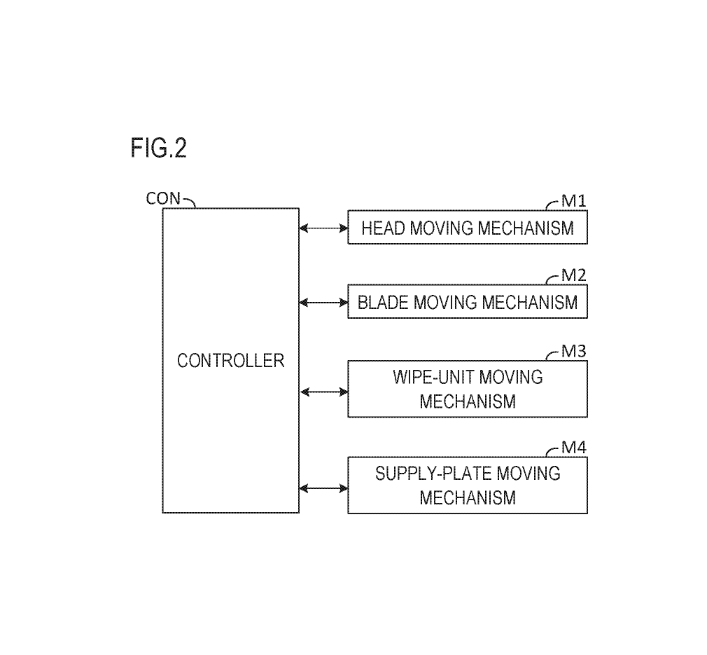

As shown in FIG. 2, the inkjet recording apparatus 100 is provided with a head moving mechanism M1, a blade moving mechanism M2, a wipe-unit moving mechanism M3, and a supply-plate moving mechanism M4. The controller CON controls the individual mechanisms M1 to M4.

### Head Unit

The head units HU, as shown in FIG. 1, are placed above the conveyor belt in the conveyance part 102. Therefore, during conveyance of the sheet P by the conveyance part 102, the sheet P on the conveyor belt and each head unit HU are opposed to each other in the up/down direction.

The head units HU are provided four in number. The four head units HU correspond to cyan, magenta, yellow, and black, respectively. The four head units HU eject ink of corresponding colors, respectively, downward. While the sheet P is under conveyance by the conveyor belt of the conveyance part 102, ink sticks to the sheet P on the conveyor belt. As a result, an image is formed on the sheet P.

The four head units HU are arranged with distances provided from one to another in the second direction D2. In other words, the four head units HU are arranged with distances provided from one to another in a conveyance direction (i.e., sub scanning direction) of the sheet P by the conveyor belt of the conveyance part 102.

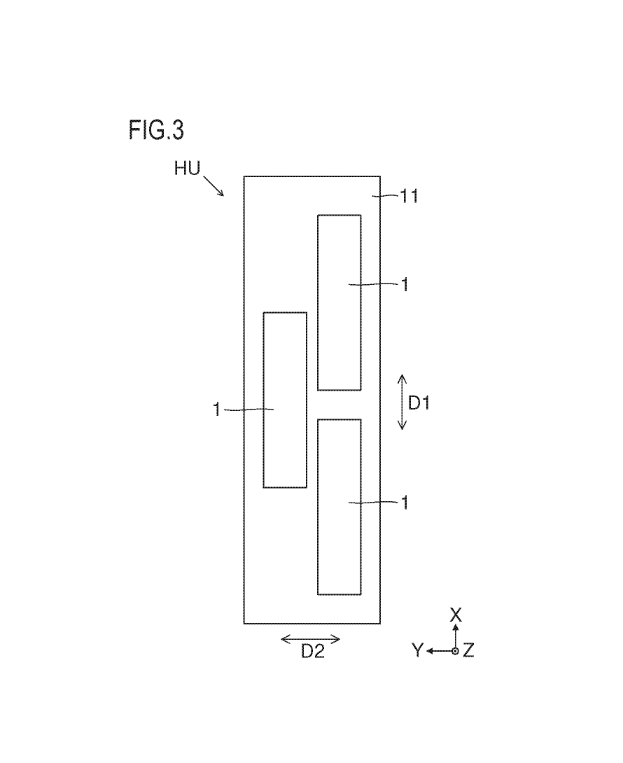

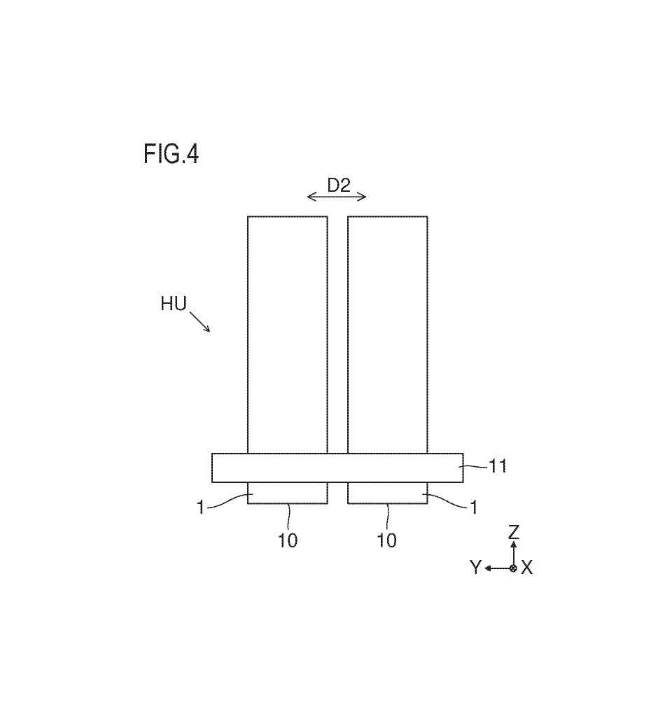

Each of the four head units HU has a configuration shown in FIGS. 3 and 4. The four head units HU are identical in configuration to one another. Accordingly, only one head unit HU is depicted in FIGS. 3 and 4. Then, by focusing on one head unit HU, its configuration will be described below.

The head unit HU includes three recording heads 1. The head unit HU also includes a head base 11. The head base 11 is a generally rectangular-shaped plate member whose plate thicknesswise direction is the up/down direction and whose longitudinal direction is the first direction D1. The head base 11 is made of, for example, sheet metal. The head base 11 holds the three recording heads 1. The three recording heads 1, while held on the head base 11, are arranged in a staggered pattern in the first direction D1.

Each recording head 1 has a downward-facing surface as a nozzle surface 10. The nozzle surface 10 has a plurality of ink ejection holes. The recording head 1 ejects ink downward from the nozzle surface 10 (i.e., plural ejection holes).

Each recording head 1 has a nozzle plate whose plate thicknesswise direction is the up/down direction. The nozzle plate forms lower portion of the corresponding recording head 1. In the nozzle plate, a plurality of openings are formed so as to extend through in the up/down direction. With this makeup, the plurality of openings of the nozzle plate serve as ink ejection holes, respectively. That is, a lower surface of the nozzle plate serves as the nozzle surface 10.

The nozzle surface 10 protrudes downward from a lower surface of the head base 11. For example, the head base 11 has three openings that extend through in the up/down direction. Nozzle plates are placed at the three openings, respectively.

The head unit HU is movable in the up/down direction. More specifically, the head unit HU is coupled to the head moving mechanism M1 (see FIG. 2). The head moving mechanism M1 includes a motor, a ball screw, and the like to perform conversion of rotational motion of the motor into rectilinear motion. The head moving mechanism M1, as it is driven, moves the head unit HU in the up/down direction.

### Maintenance Unit

The maintenance unit MU, as shown in FIG. 1, is provided four in number. In other words, the maintenance units MU counting the same number as the head units HU are provided. One maintenance unit MU is assigned to each one of the head units HU.

The maintenance units MU are placed in adjacency to their corresponding head units HU, respectively, in the second direction D2. The individual maintenance units MU perform maintenance of their corresponding head units HU (more specifically, nozzle surfaces 10), respectively.

The maintenance units MU are similar in configuration to one another. Therefore, here is described the configuration by focusing on one maintenance unit MU.

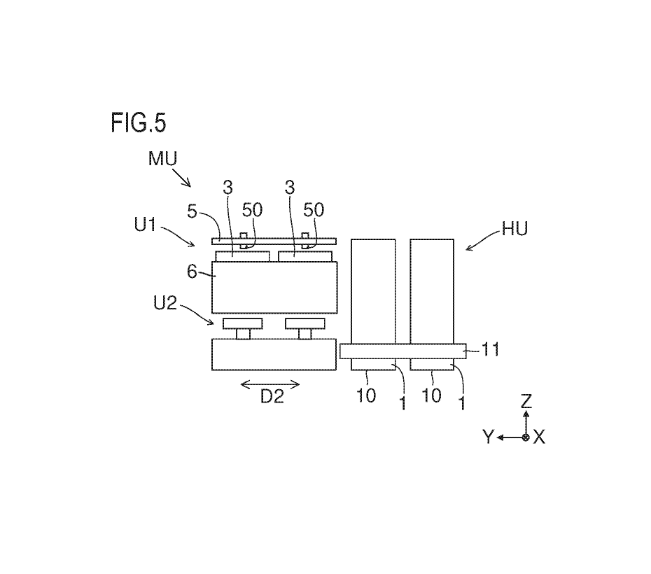

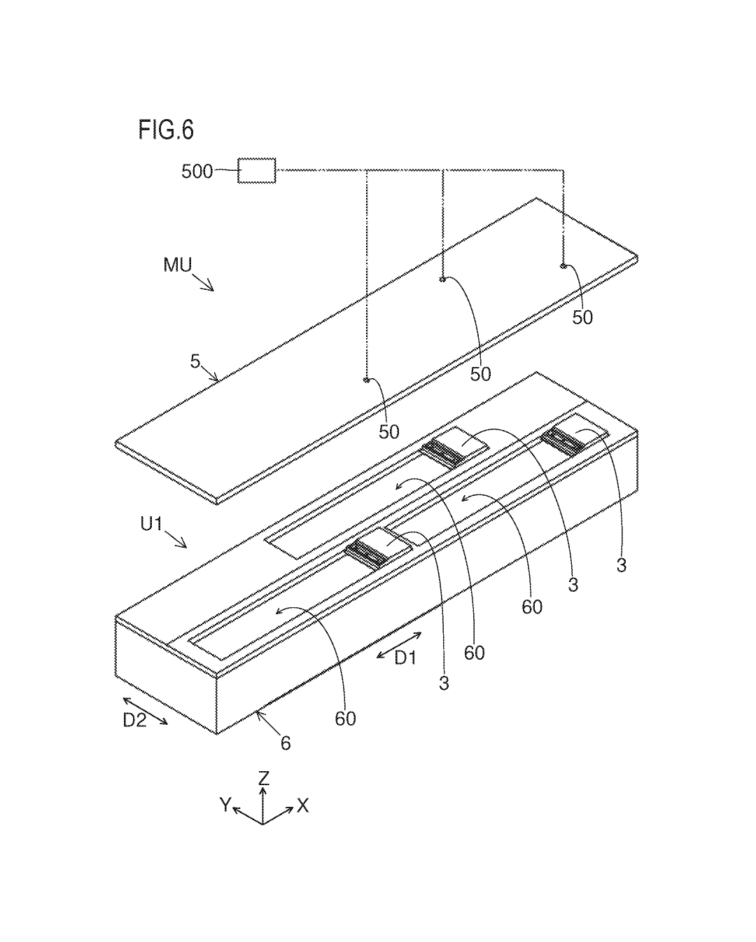

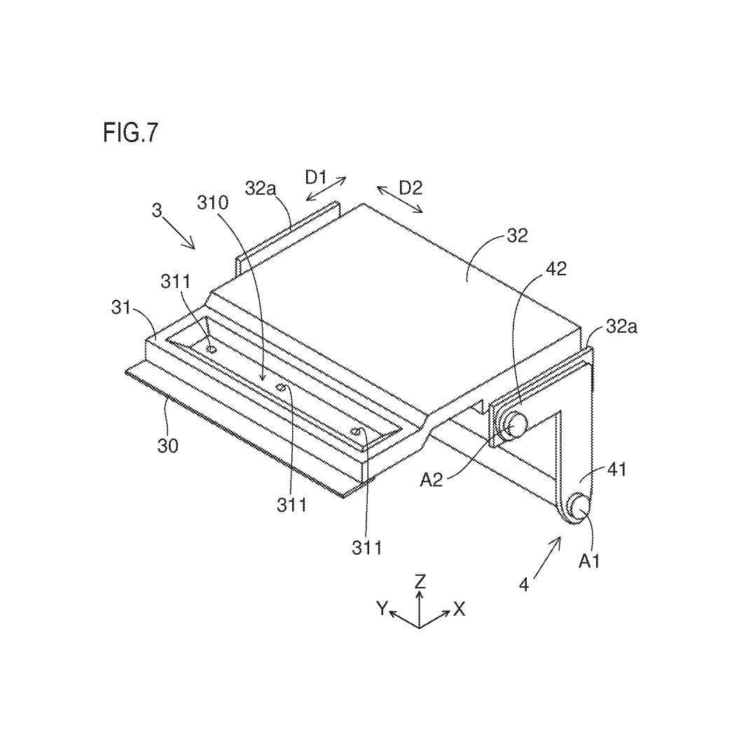

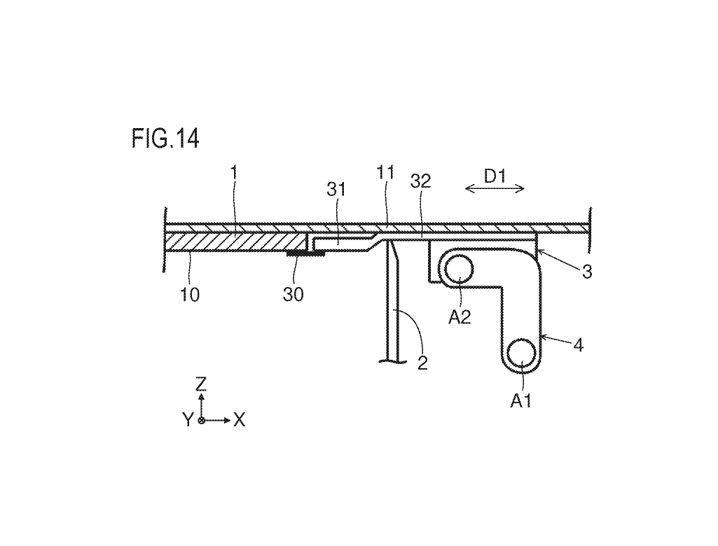

Each maintenance unit MU, as shown in FIGS. 5 and 6, includes a wipe unit U1. The wipe unit U1 cleans the nozzle surface 10 of its corresponding recording head 1 by detergent. The wipe unit U1 includes a blade 2 (see FIG. 14), a container member 3, and a support member 4 (see FIG. 7). The maintenance unit MU also includes a supply plate 5. The supply plate 5 supplies the wipe unit U1 with the detergent. In addition, the blade 2 corresponds to 'cleaning member'.

The wipe unit U1 further includes a waste liquid tray 6. The waste liquid tray 6 is a box-shaped member whose depthwise direction is the up/down direction and whose longitudinal direction is the first direction D1. Waste liquid resulting from cleaning by the wipe unit U1 is trapped in the waste liquid tray 6.

The waste liquid tray 6 has, in its top face, three openings 60 corresponding to the recording heads 1, respectively, of the head unit HU. Each opening 60 has an opening width in the first direction D1 larger than that of the nozzle surface 10 of the recording head 1, and moreover an opening width in the second direction D2 larger than that of the nozzle surface 10 of the recording head 1.

During cleaning of the head unit HU, the openings 60 are so positioned as to be opposed to the nozzle surfaces 10 of their corresponding recording heads 1, respectively, in the up/down direction. As a result of this, ink and detergent dropping down from the individual nozzle surfaces 10 pass through the openings 60, reaching to interior of the waste liquid tray 6 so as to be trapped down in the waste liquid tray 6.

Each blade 2 is, for example, a plate member made from flexible resin. The blades 2 count three in number, one for every opening 60. In other words, the blades 2 are assigned one for each recording head 1. Each blade 2 functions to wipe off contaminations on the nozzle surface 10 of its corresponding recording head 1.

Each blade 2 is movable in the first direction D1. More specifically, a carriage (not shown) is placed at each opening 60, with one blade 2 fitted to each carriage. Each carriage is coupled to the blade moving mechanism M2 (see FIG. 2). The blade moving mechanism M2 includes a motor, a feed screw, and the like to convert rotational motion of the motor into rectilinear motion. The blade moving mechanism M2, as it is driven, moves each blade 2 (i.e., each carriage) in the first direction D1 along the opening 60 of its location.

For example, rails are provided at a pair of edge portions extending in the first direction D1 of each opening 60. The pair of rails of each opening 60 extend in the first direction D1. Then, during movement in the first direction D1, the carriage is guided by the pair of rails in the opening 60 of its location. Thus, the blade 2 is movable between a one-side end portion and the other-side end portion of the opening 60 of its location, as viewed in the first direction D1.

During non-cleaning of the head unit HU, each blade 2 is placed at a one-side end portion of the opening 60 of its location, as viewed in the first direction D1. For example, a rear side of the inkjet recording apparatus 100 corresponds to the one side in the first direction D1.

During cleaning of the head unit HU, each blade 2 is put into contact with the nozzle surface 10 of the corresponding recording head 1 and, while keeping in this state, moved from the one side toward the other side of the first direction D1. In this case, the detergent is supplied and deposited to the blade 2. As a result, contaminations of the nozzle surface 10 are wiped off. That is, the nozzle surface 10 is cleaned. Furthermore, ink and detergent drop down from the nozzle surface 10.

The container members 3, counting three, are assigned one for each blade 2. In other words, the container members 3 are provided one for each opening 60. Each container member 3 is supplied with detergent. The container member 3 once contains the supplied detergent, and supplies its corresponding blade 2 with the detergent. In other words, the container member 3 makes the detergent deposited on the corresponding blade 2.

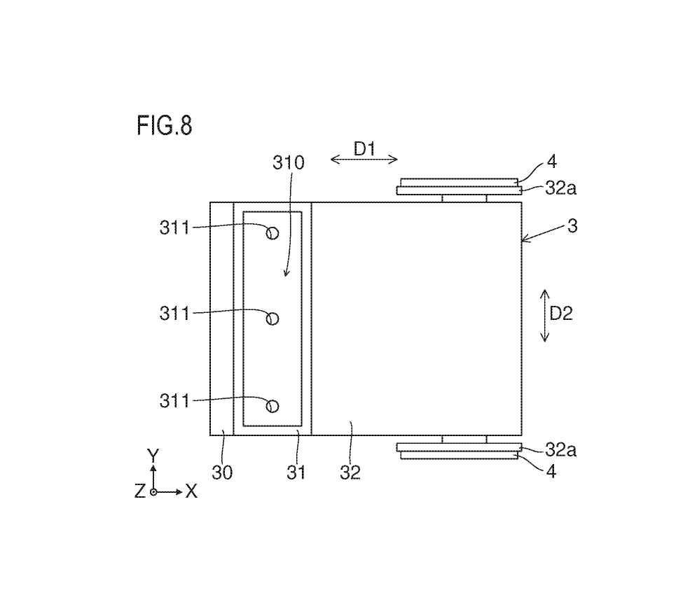

The container member 3, as shown in FIGS. 7 and 8, includes a containing part 31 and a base part 32. The container member 3 is a resin molded product in which the containing part 31 and the base part 32 are integrated together.

The containing part 31 is formed into a generally rectangular shape whose widthwise direction is the first direction D1 and whose longitudinal direction is the second direction D2, as viewed from above. The containing part 31 has a recessed area 310 with its upper part opened. The containing part 31 accepts supplied detergent via the opening of the recessed area 310, once containing the supplied detergent in the recessed area 310.

Moreover, the containing part 31 has discharge holes 311 extending through the recessed area 310 in the up/down direction. The discharge holes 311 are formed in a bottom portion of the recessed area 310. As a result, the detergent in the recessed area 310 drops down via the discharge holes 311. That is, the containing part 31 lets the detergent in the recessed area 310 flow out downward from the discharge holes 311. The detergent in the recessed area 310, as a result of flowing out downward from the discharge holes 311, is deposited on the lower surface of the containing part 31.

The base part 32 is placed so as to adjoin the containing part 31 in the first direction D1. Hereinafter, with respect to both sides of the first direction D1, the rear side of the inkjet recording apparatus 100 is defined as one side of the first direction D1, and the front side of the inkjet recording apparatus 100 is defined as the other side of the first direction D1. In this context, the base part 32 is placed so as to adjoin one side of the containing part 31 in the first direction D1.

The base part 32 is formed into a generally rectangular shape having one side line in common to the containing part 31, as viewed from above. An upper surface of the base part 32 is a flat surface. However, a recessed portion (including hole portions extending through the base part 32 in the up/down direction), which is recessed downward from the upper surface of the base part 32, may be formed in the base part 32.

In this case, the containing part 31 is positioned lower than the base part 32. That is, there is a step gap at a border between the containing part 31 and the base part 32, as viewed in the second direction D2. Because of this, the containing part 31 has openings of the recessed area 310 positioned lower than the upper surface of the base part 32.

In addition, the container member 3 includes a sheet member 30. The sheet member 30, having a sheet-like shape whose thicknesswise direction is the up/down direction, is generally rectangular-shaped as viewed in the up/down direction. A width of the sheet member 30 in the second direction D2 is generally equal to a width of the containing part 31 in the second direction D2. The sheet member 30 is affixed to the lower surface of the containing part 31 so as to protrude from the containing part 31 toward the other side of the first direction D1.

The support member 4 is provided in one set consisting of two units. One set of support members 4 is assigned to each container member 3. In other words, the support member 4 is provided in one set for every opening 60. Out of one set of support members 4, one support member 4 is placed on one side of its corresponding container member 3 in the second direction D2, while the other support member 4 is placed on the other side of its corresponding container member 3 in the second direction D2. That is, each container member 3 is sandwiched between the corresponding one set of support members 4 in the second direction D2. As a result, each one set of support members 4 supports its corresponding container member 3.

Each support member 4 is formed into a plate shape whose thicknesswise direction is the second direction D2. The support member 4 is generally L-shaped as viewed in the second direction D2. The support member 4, as viewed in the second direction D2, has a pivot hole at a one-side end portion 41 (corresponding to 'first end portion') of the generally L-shaped member, and further has a pivot hole also at the other-side end portion 42 (corresponding to 'second end portion') opposed to the one-side end portion 41. In addition, the other-side end portion 42 is located higher than the one-side end portion 41.

The one-side end portion 41 of each support member 4 is supported by a first shaft A1 extending in the second direction D2. The first shaft A1 is fitted to the waste liquid tray 6. As a result, the support member 4 is displaceable about an axis of the first shaft A1.

The other-side end portion 42 of each support member 4 supports the base part 32 of its corresponding container member 3. More specifically, a second shaft A2 extending in the second direction D2 is placed at the other-side end portion 42 of the support member 4. With the base part 32 supported by the second shaft A2 of the corresponding support member 4, the container member 3 is displaceable about an axis of the second shaft A2.

For example, the container member 3 has supported portions 32a on both sides, respectively, of the base part 32 in the second direction D2. Under this condition, by the pair of supported portions 32a being supported, the container member 3 is made displaceable about the axis of the second shaft A2.

In addition, the wipe unit U1, by its being coupled to a wipe-unit moving mechanism M3 (see FIG. 2), is made movable in the second direction D2. The wipe-unit moving mechanism M3 includes a motor, a ball screw, and the like to convert rotational motion of the motor into rectilinear motion. The wipe-unit moving mechanism M3, as it is driven, moves the wipe unit U1 in the second direction D2.

The supply plate 5, as shown in FIG. 6, has a plate thicknesswise direction aligned with the up/down direction. The supply plate 5 is formed into a generally rectangular shape whose longitudinal direction is the first direction D1 and whose widthwise direction is the second direction D2, as viewed in the up/down direction.

The supply plate 5 has supply nozzles 50. The supply nozzles 50 count three in number, one supply nozzle 50 being assigned to every container member 3. The supply nozzles 50 protrude downward of the lower surface of the supply plate 5. Each supply nozzle 50 is connected to a detergent-reservoir tank 500 via a supply tube (indicated by two-dot chain line in FIG. 6). The supply nozzle 50 lets the detergent, which is supplied from the tank 500, flow out to supply its corresponding container member 3 with the detergent.

During supply of the detergent to the container members 3, the supply plate 5 is so positioned as to cover the waste liquid tray 6 from above. In this case, the supply nozzles 50 are placed above the recessed area 310 of their corresponding container member 3. In this state, the detergent flows out from the supply nozzles 50, so that the detergent is supplied to the recessed area 310 of the container member 3.

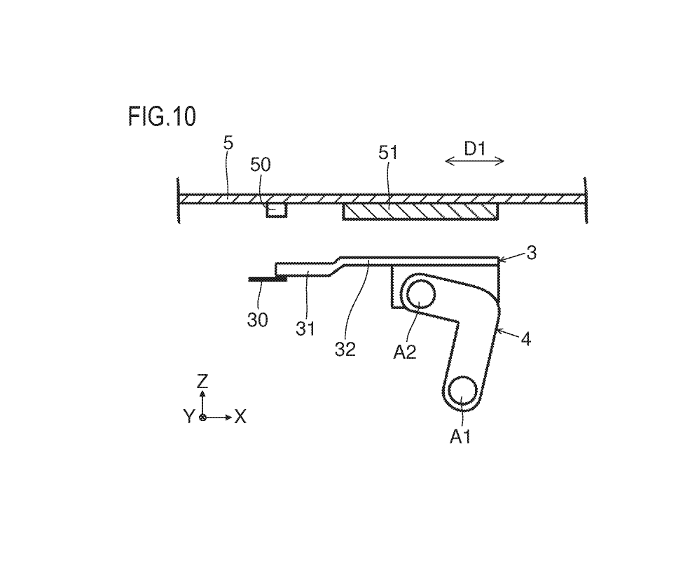

The supply plate 5 has a protruding portion 51 on its lower surface (see FIG. 10). The protruding portion 51 protrudes downward in a planar shape. For example, a plate member is placed on the lower surface of the supply plate 5 so that the plate member acts as the protruding portion 51. The plate member as the protruding portion 51 is a metal plate (e.g., stainless plate). As will be detailed later, the supply plate 5 has the protruding portion 51 put into contact with an upper surface of the base part 32, making the container member 3 pressed from above to below.

In addition, the supply plate 5, by its being coupled to the supply-plate moving mechanism M4 (see FIG. 2), is movable in the up/down direction. The supply-plate moving mechanism M4 includes a motor, a ball screw, and the like to convert rotational motion of the motor into rectilinear motion. The supply-plate moving mechanism M4, as it is driven, moves the supply plate 5 in the up/down direction.

Also, as shown in FIG. 5, the maintenance unit MU is equipped with a cap unit U2. The cap unit U2 covers the nozzle surface 10 of each recording head 1 in its corresponding head unit HU.

### Supply of Detergent to Wipe Unit

Hereinbelow, by focusing on one wipe unit U1 as well as its corresponding supply plate 5, supply operation of the detergent to the wipe unit U1 will be described. It is noted that the other wipe units U1 and their corresponding supply plates 5 also exhibit behavior similar to the following description.

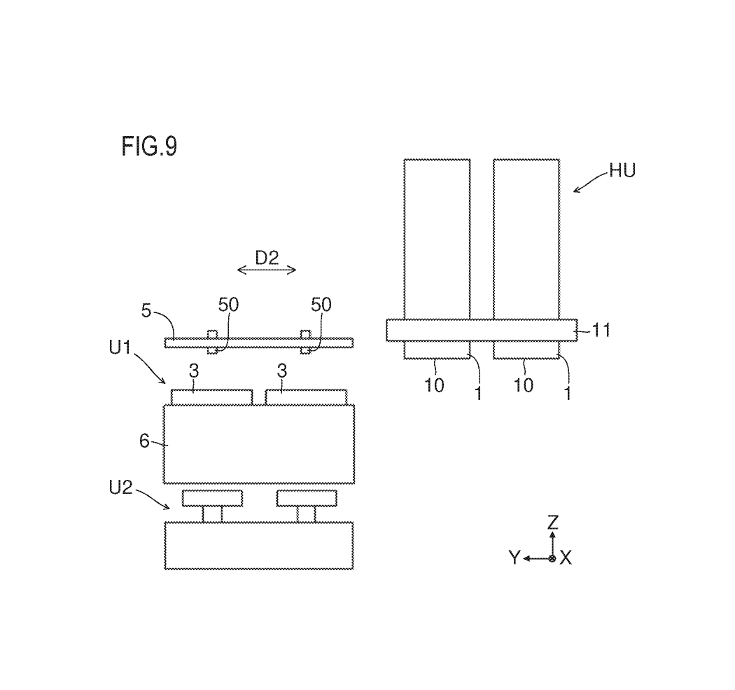

During supply of the detergent to the wipe unit U1, as shown in FIG. 9, the waste liquid tray 6 is positioned under the supply plate 5. A positional relationship between the container member 3 and the supply plate 5 as viewed in the second direction D2 in this case is shown in FIG. 10.

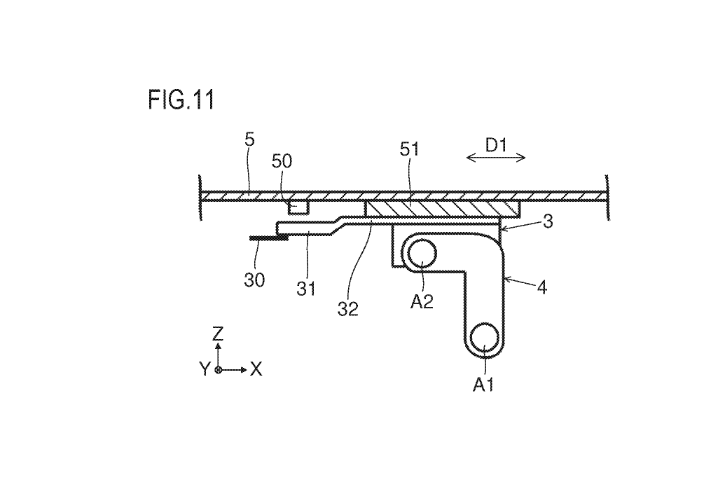

Then, in this state, the supply plate 5 is moved down. As a result, the supply plate 5 presses the container members 3 from above to below. That is, the supply plate 5 makes each container member 3 displaced from supply stand-by position to supply position. The position of the container member 3 shown in FIG. 10 is the supply stand-by position, and the position of the container member 3 shown in FIG. 11 is the supply position.

More specifically, as the supply plate 5 is moved down, the protruding portion 51 of the supply plate 5 is put into contact with the upper surface of the base part 32. In this case, the containing part 31 is positioned lower than the base part 32. For this reason, when the supply plate 5 is moved down, the supply plate 5 is kept out of contact with the containing part 31. That is, the supply plate 5 presses the base part 32 from above to below without making contact with the containing part 31.

When the base part 32 of the container member 3 is pressed by the supply plate 5 from above to below, the support member 4 is displaced about the axis of the first shaft A1. Also, the container member 3 is displaced about the axis of the second shaft A2. As a result, with the opening of the recessed area 310 kept facing upward, the containing part 31 is displaced downward while being displaced from the one side to the other side of the first direction D1. As a result, the container member 3 is displaced from the supply stand-by position shown in FIG. 10 to the supply position shown in FIG. 11.

Although not shown, each support member 4 is biased by a first biasing member, such as a torsion coil spring placed on the first shaft A1, in a direction opposite to the direction in which the container member 3 is displaced from supply stand-by position to supply position. The container member 3 is biased by a second biasing member, such as a torsion coil spring placed on the second shaft A2, in a direction opposite to the direction in which displacement is applied from supply stand-by position to supply position.

Accordingly, while not pressed by the supply plate 5, the container member 3 is held in the supply stand-by position (position shown in FIG. 10). On the other hand, by the container member 3 being pressed by the supply plate 5, each support member 4 is displaced about the axis of the first shaft A1 against the biasing force of the first biasing member. Also by the container member 3 being pressed by the supply plate 5, the container member 3 is displaced about the axis of the second shaft A2 against the biasing force of the second biasing member. With the container member 3 pressed by the supply plate 5, the container member 3 is held in the supply position (position shown in FIG. 11).

After the container member 3 has been displaced from supply stand-by position to supply position, the detergent is supplied from the supply plate 5 to the container member 3. That is, the container member 3, in the supply position, accepts supply of the detergent from the supply plate 5.

While the container member 3 is in the supply position, the recessed areas 310 of the containing part 31 and the supply nozzles 50 are opposed to each other, respectively, in the up/down direction. In this state, a lower end of each supply nozzle 50 may be placed above the opening of the recessed area 310, or otherwise, the lower end of each supply nozzle 50 may be positioned lower than the opening of the recessed area 310 (i.e., inside the recessed area 310).

Then, with each container member 3 in the supply position, the detergent flows out of the supply nozzles 50. As a result, the detergent is supplied to the containing part 31 of the container member 3. That is, the detergent is trapped in the recessed area 310 of the containing part 31.

After the detergent has been supplied to the container member 3, the supply plate 5 is moved up so as to get upwardly farther from the container member 3. That is, contact of the supply plate 5 with the upper surface of the base part 32 is released. As a result, a state as shown in FIG. 11 comes up.

In this embodiment, during supply of the detergent from the supply plate 5 to the container member 3, the container member 3 can be displaced from the supply stand-by position to the supply position without making the supply plate 5 put into contact with the containing part 31. Consequently, there is no need for making the supply plate 5 put into contact with the containing part 31.

With this configuration, since the supply plate 5 keeps out of contact with the containing part 31, the detergent of the recessed area 310 becomes less likely to be deposited on the supply plate 5. As a result, after the supply of the detergent from the supply plate 5 to the container member 3, when the supply plate 5 is moved upwardly farther from the container member 3, the detergent of the recessed area 310 can be prevented from scattering all around. That is, scattering of the detergent inside the apparatus body of the inkjet recording apparatus 100 can be suppressed.

On condition that the detergent has scattered inside the apparatus body of the inkjet recording apparatus 100 so as to be deposited on members inside the apparatus body, there is a possibility that the sheet P might be stained with the detergent. On the other hand, given no scattering of the detergent inside the apparatus body of the inkjet recording apparatus 100, stains of the sheet P with the detergent can be suppressed.

Also in this embodiment, the container member 3 is supported by the support members 4. More specifically, each support member 4 has its one-side end portion supported by the first shaft A1. The second shaft A2 is placed at the other-side end portion 42 of the support member 4. The container member 3 has its base part 32 supported by the second shaft A2.

With this configuration, not the containing part 31 but the base part 32 out of the container member 3 is pressed from above to below, so that the container member 3 is displaced from the supply stand-by position to the supply position without causing tilts of the opening of the recessed area 310 relative to the horizontal direction. In other words, as the container member 3 is released from being pressed, the container member 3 is displaced from the supply position to the supply stand-by position without tilting of the opening of the recessed area 310 relative to the horizontal direction. Thus, after supply of the detergent from the supply plate 5 to the container member 3, spillover of the detergent from the opening of the recessed area 310 can be suppressed when the container member 3 is displaced from the supply position to the supply stand-by position.

Further with this configuration, pressing the base part 32 allows the posture of the container member 3 in the supply position to be stabilized more than pressing the containing part 31. Thus, while the container member 3 is in the supply position, the opening of the recessed area 310 becomes less likely to be tilted relative to the horizontal direction.

Also in this embodiment, by the supply plate 5 being displaced in the up/down direction (moved down), the base part 32 of the container member 3 is pressed from above to below by the supply plate 5. As a result, the container member 3 can be displaced from the supply stand-by position to the supply position without providing any additional member for pressing the container member 3. Furthermore, it may be contrived as a modification that, by the container member 3 being displaced in the up/down direction (moved up), the base part 32 of the container member 3 is pressed from above to below by the supply plate 5.

Also in this embodiment, the containing part 31 is positioned lower than the base part 32. As a result, the base part 32 can be easily pressed from above to below without making the supply plate 5 put into contact with the containing part 31.

Also in this embodiment, downward-displacement quantity of the container member 3 can be easily adjusted by changing the up/down-direction thickness of the protruding portion 51, which is part of the supply plate 5.

### Cleaning with Detergent by Wipe Unit

Hereinbelow, by focusing on one wipe unit U1 as well as its corresponding head unit HU, cleaning operation with the detergent by the wipe unit U1 will be described. It is noted that the other wipe units U1 and their corresponding head units HU also exhibit behavior similar to the following description.

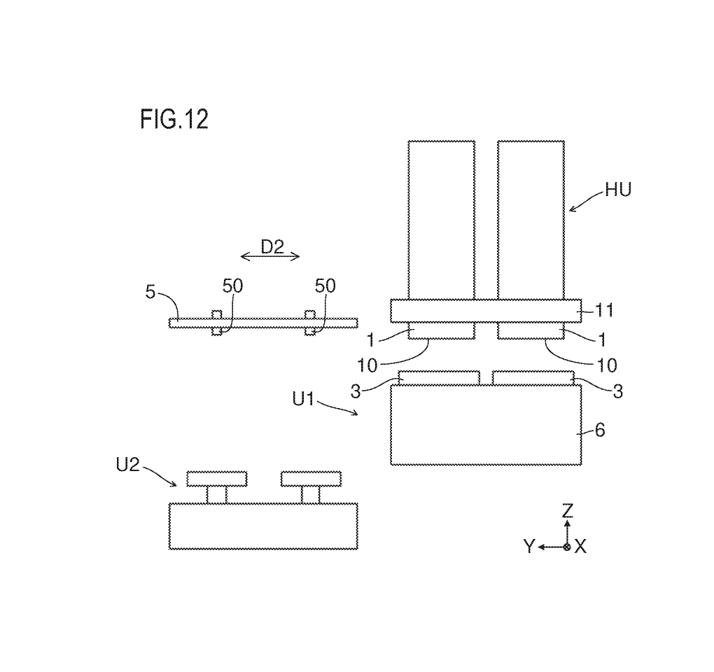

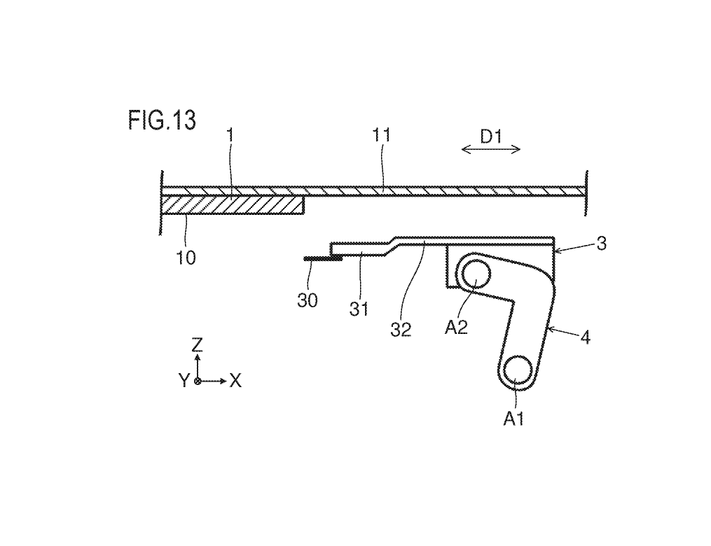

During the cleaning with the detergent by the wipe unit U1, as shown in FIG. 12, the waste liquid tray 6 is positioned under the head unit HU. When the head unit HU is moved up so that the wipe unit U1 is moved in the second direction D2, the waste liquid tray 6 is positioned under the head unit HU. A positional relationship between the recording head 1 and the container member 3 as viewed in the second direction D2 in this case is shown in FIG. 13. Under this condition, the head base 11 has its lower surface opposed to the upper surface of the base part 32 in the up/down direction. That is, the head base 11 is so positioned as to be from-above contactable with the base part 32.

Then, in this state, the head unit HU including the head base 11 is moved down. As a result, the head base 11 presses the container member 3 from above to below. That is, the head base 11 makes the container member 3 displaced from cleaning stand-by position to cleaning position. A position of the container member 3 shown in FIG. 13 is the cleaning stand-by position, and a position of the container member 3 shown in FIG. 14 is the cleaning position. It is noted that the cleaning stand-by position corresponds to a 'first position', and the cleaning position corresponds to a 'second position'.

More specifically, by the head unit HU being moved down, the head base 11 comes into contact with the upper surface of the base part 32. In this case, the containing part 31 is positioned lower than the base part 32. Therefore, when the head unit HU is moved down, the head base 11 keeps out of contact with the containing part 31. That is, the head base 11 presses the base part 32 from above to below without making contact with the containing part 31.

When the base part 32 of the container member 3 is pressed by the head base 11 from above to below, each support member 4 is displaced about the axis of the first shaft A1. Also, the container member 3 is displaced about the axis of the second shaft A2. As a result, with the opening of the recessed area 310 kept facing upward, the containing part 31 is displaced from one side to the other side of the first direction D1 while being displaced downward. As a result, the container member 3 is displaced from the cleaning stand-by position shown in FIG. 13 to the cleaning position shown in FIG. 14.

Although not shown, each support member 4 is biased by the first biasing member, such as a torsion coil spring placed on the first shaft A1, in a direction opposite to the direction in which the container member 3 is displaced from cleaning stand-by position to cleaning position. The container member 3 is biased by the second biasing member, such as a torsion coil spring placed on the second shaft A2, in a direction opposite to the direction in which displacement is applied from cleaning stand-by position to cleaning position.

Accordingly, while not pressed by the head base 11, the container member 3 is held in the cleaning stand-by position (position shown in FIG. 13). On the other hand, by the container member 3 being pressed by the head base 11, each support member 4 is displaced about the axis of the first shaft A1 against the biasing force of the first biasing member. Also, the container member 3, by its being pressed by the head base 11, is displaced about the axis of the second shaft A2 against the biasing force of the second biasing member. The container member 3, while pressed by the head base 11, is held in the cleaning position (position shown in FIG. 14).

As the container member 3 has been displaced from cleaning stand-by position to cleaning position, it results that the recording head 1 and the containing part 31 are placed so as to be adjacent to each other in the first direction D1. More specifically, a resulting state is that the containing part 31 is placed on one side of the recording head 1 in the first direction D1. Also, the lower surface of the containing part 31 becomes generally flush with the nozzle surface 10. Under this condition, a slight clearance exists between the recording head 1 and the containing part 31 in the first direction D1. However, a portion protruding from the containing part 31 out of the sheet member 30 is positioned lower than the nozzle surface 10. As a result, the clearance between the recording head 1 and the containing part 31 in the first direction D1 is blocked from below by the sheet member 30.

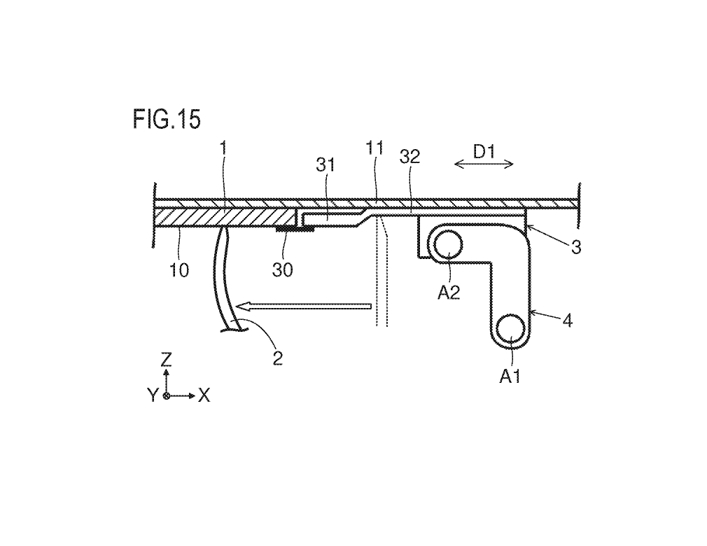

Further, as shown in FIG. 14, the blade 2 is placed on a lower-surface side of the container member 3 as well as on one side of the containing part 31 in the first direction D1 (i.e., under the base part 32). Then, in this state, the blade 2 is moved from one side toward the other side of the first direction D1 as shown in FIG. 15. As a result, the nozzle surface 10 is cleaned by the blade 2. In FIG. 15, the blade 2 before its movement is indicated by broken line. Also, a direction in which the blade 2 is moved at the beginning of the movement is indicated by a hollow arrow.

By the blade 2 being moved from one side toward the other side of the first direction D1, the blade 2 first passes through under the containing part 31 while keeping in contact with the lower surface of the containing part 31. In this process, the detergent flowing out from the discharge holes 311 is deposited on the blade 2. That is, the detergent is supplied to the blade 2.

Subsequently, the blade 2 is moved in the first direction D1 under the clearance between the recording head 1 and the containing part 31 in the first direction D1. However, since the clearance is blocked from below by the sheet member 30, infiltration of the detergent into the clearance is suppressed.

Next, the blade 2 with the detergent deposited thereon is moved under the nozzle surface 10 in the first direction D1 while keeping in contact with the nozzle surface 10. As a result, contaminations on the nozzle surface 10 are wiped off by the blade 2. That is, the nozzle surface 10 is cleaned by the blade 2. Contaminations (including ink and detergent) wiped off by the blade 2 drop down, reaching the waste liquid tray 6 via the opening 60.

In this embodiment, during the cleaning of the nozzle surface 10 by the blade 2 (in other words, during supply of the detergent from the container member 3 to the blade 2), the container member 3 can be displaced from the cleaning stand-by position to the cleaning position without making the head base 11 put into contact with the containing part 31. Consequently, there is no need for making the head base 11 put into contact with the containing part 31.

With this configuration, since the head base 11 keeps out of contact with the containing part 31, the detergent of the recessed area 310 becomes less likely to be deposited on the head base 11. As a result, after the cleaning of the nozzle surface 10 by the blade 2, when the head base 11 is moved upward farther from the container member 3, the detergent of the recessed area 310 can be prevented from being scattered all around. That is, the detergent can be prevented from being scattered inside the inkjet recording apparatus 100.

Also in this embodiment, by the container member 3 being supported by the support members 4, and by not the containing part 31 but the base part 32 out of the container member 3 being pressed from above to below, the container member 3 is displaced from the cleaning stand-by position to the cleaning position without tilting of the opening of the recessed area 310 relative to the horizontal direction. As a result, spillover of the detergent from the opening of the recessed area 310 can be suppressed when the container member 3 is displaced from the cleaning stand-by position to the cleaning position.

Further, with this configuration, pressing the base part 32 allows the posture of the container member 3 in the cleaning position to be stabilized more than pressing the containing part 31. As a result, with the container member 3 in the cleaning position, the opening of the recessed area 310 becomes less likely to tilt relative to the horizontal direction.

Also in this embodiment, by the head unit HU being displaced in the up/down direction (moved down), the base part 32 of the container member 3 is pressed from above to below by the head base 11. As a result, the container member 3 can be displaced from the cleaning stand-by position to the cleaning position without providing any additional member for pressing the container member 3. Furthermore, it may be contrived as a modification that, by the container member 3 being displaced in the up/down direction (moved up), the base part 32 of the container member 3 is pressed from above to below by the head base 11.

Also in this embodiment, the containing part 31 is positioned lower than the base part 32. As a result, the base part 32 can be easily pressed from above to below by the head base 11 without making the head base 11 put into contact with the containing part 31.

The embodiment disclosed herein should be construed as not being limitative but being an exemplification at all points. The scope of the disclosure is defined not by the above description of the embodiment but by the appended claims, including all changes and modifications equivalent in sense and range to the claims.

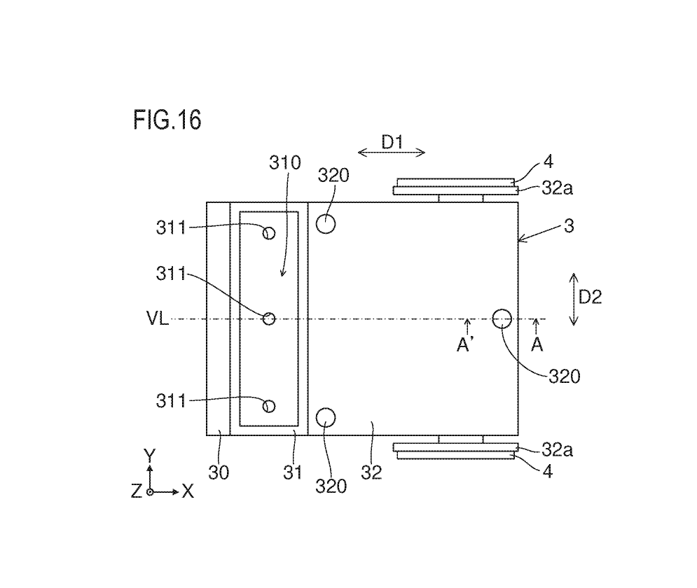

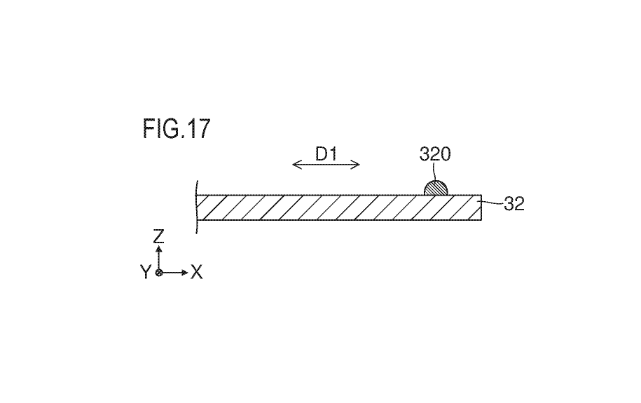

For example, in this embodiment, the upper surface of the base part 32 is a flat surface. However, the disclosure is not limited to this, and a plurality of protrusions 320 may be provided on the upper surface of the base part 32, like a modification shown in FIGS. 16 and 17.

In the modification, three protrusions 320 are provided in the upper surface of the base part 32. Those three protrusions 320 individually protrude higher than the other portions of the base part 32. Moreover, the number of protrusions 320 to be provided may be four or more without limitation to three.

The three protrusions 320 individually protrude upward from the upper surface of the base part 32. Further, each of the three protrusions 320 has a fore end formed into a hemispherical shape (R shape). Further, the three protrusions 320 are so positioned as to be in line symmetry with respect to a virtual line VL passing through a second-direction-D2 center of the base part 32 in the first direction D1, as viewed from above.

With this configuration, the supply plate 5 presses the three protrusions 320 from above to below so that the container member 3 is displaced from the supply stand-by position to the supply position. Also, the head base 11 presses the three protrusions 320 from above to below so that the container member 3 is displaced from the cleaning stand-by position to the cleaning position.

In this modification, when the container member 3 is displaced from the supply stand-by position to the supply position, the container member 3 and the supply plate 5 are brought into point contact with each other, involving a resistance smaller than that of plane contact, so that the container member 3 can be smoothly displaced from the supply stand-by position to the supply position. Also, when the container member 3 is displaced from the cleaning stand-by position to the cleaning position, the container member 3 and the head base 11 are brought into point contact with each other, involving a resistance smaller than that of plane contact, so that the container member 3 can be smoothly displaced from the cleaning stand-by position to the cleaning position.

Also in the modification, since the three protrusions 320 are so positioned as to be in line symmetry with respect to the virtual line VL, there can be obtained a better pressing balance in pressing of the container member 3 from above to below. Furthermore, since the three protrusions 320 each have a fore end formed into a hemispherical shape, the protrusions 320 are less likely to undergo cuts or nicks or the like of their fore ends.

What is claimed is:

1. An inkjet recording apparatus comprising:
a head unit including a recording head having a nozzle surface for ejecting ink;
a cleaning member for cleaning the nozzle surface with a detergent; and
a container member which contains the detergent and which, by being pressed from above to below, is displaced from a first position to a second position, the container member functioning in the second position to supply the cleaning member with the detergent, wherein
the container member includes:
a containing part which has an upwardly-opening recessed area for containing the detergent therein; and
a base part which adjoins the containing part in a first direction perpendicular to an up/down direction, and
the head unit has a head base for holding the recording head, and
the head base presses the base part from above to below without making contact with the containing part so that the container member is displaced from the first position to the second position.

2. The inkjet recording apparatus according to claim 1, wherein
the containing part has, in the recessed area, a discharge hole extending through in the up/down direction so as to allow the detergent in the recessed area to flow out downward from the discharge hole,
the cleaning member is movable in the first direction,
during cleaning of the nozzle surface by the cleaning member, by the container member being displaced from the first position to the second position, the recording head and the containing part are placed so as to be adjacent to each other in the first direction,
by the cleaning member being moved in the first direction under the containing part, the detergent flowing out downward from the discharge hole is deposited on the cleaning member, and
as the cleaning member with the detergent deposited thereon is moved in the first direction while keeping in contact with the nozzle surface, the nozzle surface is cleaned.

3. The inkjet recording apparatus according to claim 1, further comprising
a support member which has a first end portion supported by a first shaft extending in a second direction perpendicular to both the up/down direction and the first direction, and which is displaceable about an axis of the first shaft, wherein
the support member has a second end portion at which a second shaft extending in the second direction is placed, the second end portion being positioned higher than the first end portion,
by the base part being supported by the second shaft, the container member is displaceable about an axis of the second shaft, and
when the base part is pressed from above to below by the head base, the support member is displaced about the axis of the first shaft, and when the container member is displaced about the axis of the second shaft, the containing part is displaced in the first direction and moreover displaced downward while the opening of the recessed area is kept facing upward.

4. The inkjet recording apparatus according to claim 1, wherein
by at least one of the head unit and the container member being displaced in the up/down direction, the head base presses the base part from above to below without making contact with the containing part.

5. The inkjet recording apparatus according to claim 1, wherein
the containing part is positioned lower than the base part.

6. The inkjet recording apparatus according to claim 1, wherein
the base part has three or more protrusions which protrude upward so as to be higher than the other portions of the base part, and
by the head base pressing the three or more protrusions from above to below, the container member is displaced from the first position to the second position.

7. The inkjet recording apparatus according to claim 6, wherein
the three or more protrusions are so positioned as to be in line symmetry with respect to a virtual line which passes in the first direction through a center of the base part in the second direction perpendicular to the first direction, as viewed from above.
